(19) United States
(12) Patent Application Publication
(10) Pub. No.: US 2026/0342074 A1
(43) Pub. Date: Oct. 29, 2026

(54) Method and Protective Device for Protecting a Device From a Fault Current, and Correspondingly Configured Motor Vehicle

(71) Applicant: Bayerische Motoren Werke Aktiengesellschaft, Muenchen (DE)

(72) Inventor: Martin BAUMANN, Muenchen (DE)

(21) Appl. No.: 19/124,366

(22) PCT Filed: Sep. 15, 2023
(86) PCT No.: PCT/EP2023/075453

§ 371 Date: Apr. 25, 2025

(30) Foreign Application Priority Data
Oct. 28, 2022 (DE) 10 2022 128 623.1

(51) Int. Cl. H02H 3/08; H02H 1/00

(52) U.S. Cl. CPC H02H 3/08; H02H 1/0007

(57) ABSTRACT

The present disclosure relates to a method for protecting an electronic device from a fault current and a corresponding protective device. In the method, an increase in the normal operating current which is presently expected when there is no fault and a respective increase in the fault current which is presently expected when there is a fault are determined. An increase in a prevailing measuring current which is actually present is also determined. A measured current through the fuse is identified as a fault current when the increase in the fault current is greater than the increase in the normal operating current by more than a predetermined threshold value and simultaneously a difference between the increase in the fault current and the increase in the measuring current is lower than a predetermined difference threshold value. In this case, the fuse is then tripped automatically.

### BACKGROUND AND SUMMARY

The present invention relates to a method and to a protective device for protecting an electrical and/or electronic device against a fault current. The invention further relates to a correspondingly equipped motor vehicle.

Nowadays, electrical and electronic systems of an incalculable variety are employed. In order to prevent damage or safety risks, fuses can be employed. However, depending upon the application, this employment can also be associated with problems. For example, conventional fusible links can have a tripping time of several ms, such that the response thereof is thus comparatively slow. In principle, electronic switches can respond more rapidly, which response, however, particularly in the event of relatively high inductances, can also be associated with a hazard potential.

By way of a potential solution, in DE 10 2011 121 604 A1, a method is described for protecting an electronic system against an electric overcurrent and short-circuit. Herein, an ascertained actual value for a current rise of an operating current is compared with a target value which, as a maximum permissible current rise of the operating current, is dynamically adjusted by a control device, according to a design rating and/or a present current requirement on the system. If the actual value of the current rise exceeds the first target value, a circuit-breaker is tripped by the control device for the interruption of the operating current. It is thus intended to improve safety by enabling the prompt detection and subsequent elimination of a potential short-circuit hazard. In this context, however, it can also be problematic to achieve a reliable distinction between the operating current and a fault current by reference to the current rise alone, such that, in the event of a fault, high energy levels can nevertheless occur, and the management thereof will be required.

By way of a further approach, DE 10 2009 007 969 A1 describes a short-circuit protection device for limiting short-circuit currents in high-voltage DC power grids. Herein, a first switch is connected in parallel with an electrical resistance for commutating and limiting the short-circuit current, which switch bridges the resistance in the event of the absence of a short-circuit. A monitoring and control device is further provided for monitoring the current in the switch and for opening the switch, in the event that the current in the switch exceeds a stipulated limiting value. The secure management of a short-circuit current associated with a short-circuit is intended accordingly.

The object of the present invention is the enablement of a particularly reliable and secure fault current protection.

This object is fulfilled by the subject matter of the independent patent claims. Further potential configurations of the invention are disclosed in the sub-claims, in the description and in the figures. Features, advantages and potential configurations which are presented in the context of the description of one element of the subject matter of the independent claims are to be considered as at least analogous to features, advantages and potential configurations of the respective subject matter of the other independent claims, and to any potential combination of subject matter of the independent claims, optionally in association with one or more of the sub-claims.

A method according to the invention can be employed for protecting an electrical and/or electronic device against a fault current, by means of a fuse. A fuse of this type can thus be automatically opened or tripped in order to prevent any damage to the device by a fault current, i.e. for example an overcurrent or a short-circuit current, or for the prevention or reduction of the potentially damaging effects of a fault current of this type. A method according to the invention may comprise multiple process steps, each of which can be employed in the operation of the device.

In one process step of the method according to the invention, a respective presently anticipated normal operating current under no-fault conditions, i.e. in the event of the normal no-fault operation of the device, is determined at a stipulated location in the device. In particular, this location can be the fuse such that, in other words, it can thus be determined which normal operating current, in each case, is presently intended to flow through the fuse. Additionally, however, another location for determining the normal operating current can also be stipulated or predefined, for example along a conductor which incorporates the fuse, immediately up-circuit or down-circuit of the fuse, or similar. This can enable a correspondingly flexible application of the method. Moreover, by reference to the anticipated normal operating current or to a temporal characteristic of the anticipated normal operating current, a respectively corresponding presently anticipated normal operating current rise under no-fault conditions can be determined. In other words, the respective presently anticipated gradient of the normal operating current under no-fault conditions is determined, for example in A/s. Depending upon the configuration of the device, this normal operating current rise can be different or variable, even under no-fault conditions. For example, in the case of a capacitive load which is protected by, or supplied via the fuse, the normal operating current can be a correspondingly anticipated capacitive charging current, wherein the normal operating current rise can then be dependent upon the capacitance of the load.

In a further process step of the method according to the invention, a respective presently anticipated fault current at the or a stipulated location in the event of a fault, particularly in the event of an electrical short-circuit, and a respectively corresponding fault current rise, i.e. a respective presently anticipated gradient of the fault current, are determined.

In each case, for determining these variables, for example, stipulated electrical parameters which describe or characterize the device can be employed. Likewise, for example, the electric voltage in the device, or between two stipulated points, can be measured over time and employed as a basis or input for determining the above-mentioned variables.

In a further process step of the method according to the invention, an actual current flowing through the stipulated location is measured over time. This actual measured current can also be described herein as a measuring current. By reference to the measured temporal characteristic of the measuring current, moreover, in each case, a corresponding present and actual measuring current rise, which is thus actually observed, i.e. a corresponding gradient of the measuring current, is determined.

The measuring current is then detected as a fault current, and the fuse is automatically tripped, if at least two stipulated conditions are fulfilled. The fuse can thus be automatically opened, in order to interrupt the fault current flowing through the device or fuse, and thus also through an element of the device which is to be protected. A first condition for detecting the measuring current as a fault current, rather than as a normal operating current, is then fulfilled if the presently anticipated fault current rise, in the presence of a fault, exceeds the presently anticipated normal operating current rise, under no-fault conditions, by a margin which exceeds a stipulated threshold value. To this end, in a continuous or quasi-continuous manner, or at a correspondingly high frequency, for the achievement or enablement of a sufficiently rapid protective action, the anticipated fault current rise and the anticipated normal operating current rise can be determined, and a corresponding comparison executed. In particular, the magnitudes of these current rises can be mutually compared in each case. By means of the stipulated threshold value, a corresponding fault tolerance or confidence interval can be adjusted or considered. The threshold value, for example, can be minimized in consideration of a given or achievable accuracy or reliability of the determination of the anticipated fault current rise and of the anticipated normal operating current rise in a respective application. This can be dependent, for example, upon an accuracy of available parameters or parameter values for describing or characterizing the device, a resolution of a corresponding model and/or upon further similar factors.

A second condition for detecting the measuring current as a fault current is provided in that a differential between the presently anticipated fault current rise in the presence of a fault and the present measuring current rise, particularly the magnitude of this differential, is lower than a stipulated differential threshold value. To this end, for example, the magnitude of the differential between the measuring current rise and the anticipated fault current rise can be compared with a magnitude of the fault current rise which is increased by a stipulated confidence value or confidence component, or similar.

In other words, a fault current can thus be detected, and the fuse automatically tripped accordingly, immediately the anticipated normal operating current rise and the anticipated fault current rise mutually differ to a sufficient extent to enable a distinction between a fault, for example a short-circuit, and normal operation with a corresponding degree of confidence, or with a correspondingly high confidence interval, and immediately the anticipated fault current rise and the actual measuring current rise coincide to a sufficiently close margin to enable the actual identification of a fault or a short-circuit with a corresponding degree of confidence, or with a correspondingly high confidence interval.

A corresponding fault current, short-circuit or similar can be directly isolated by the opening of the fuse, immediately upon the identification or determination thereof.

By means of the method proposed herein, a particularly prompt and particularly reliable distinction between a routine maximum operating current and a fault current or short-circuit current is enabled, which distinction, in conventional overcurrent trip circuits, for example on the grounds of a capacitance of the device or of a corresponding load, is not readily possible in a correspondingly rapid manner. In comparison with a conventional overcurrent trip circuit, which responds exclusively to an overshoot of a threshold value by a measured current, a particularly prompt detection of a fault current is thus enabled by means of the present invention. This applies on the grounds that, in this case, not only the absolute value of the current flux, but also the current rise are monitored or considered. Thus, ultimately, a response can be generated and the fuse tripped, even in the event of a particularly low absolute fault current. This can enable a reduction of the quantity of energy, the management of which is required in the event of a corresponding fault, in comparison with conventional overcurrent trip circuits, with an otherwise identical configuration of the device and of the fuse. In turn, this can generate a corresponding reduction of consequential damage associated with the automatic tripping of the fuse, thus contributing to an overall improvement of the robustness and security of the device and/or of the protective device.

In a potential further development of the present invention, the anticipated normal operating current or the corresponding normal operating current rise, and the anticipated fault current or the corresponding fault current rise are calculated using two different specific models. Specific models of this type can also model the device and the electrical behavior or current conducting behavior thereof. A first model can model regulation and specification-compliant, and thus no-fault normal operation. Conversely, a distinct and, in particular, different second model can model a fault or malfunction of the device. It is also possible for the second model to model multiple different types or manifestations of faults, or a corresponding behavior of the device, and/or multiple different second models can be specified, in order to model different types or manifestations of faults, or corresponding operations or behaviors of the device. A correspondingly flexible and accurate response to various situations is thus enabled, such that a correspondingly rapid and reliable tripping of the fuse is thus ensured, for example, even in different fault situations.

By means of the model-based calculation of current rises proposed herein, a particularly simple and flexible adaptation to different situations, operating strategies and/or alterations of the device and/or, for example, of a load which is connected thereto, can be accommodated. A corresponding adaptation of a specific calculation model is thus enabled, for example, in a significantly simpler, more rapid and flexible manner, in particular, for example, dynamically during the operation of the device, in comparison with a corresponding adaptation, for example, of a hardware circuit or similar which represents the corresponding behavior of the device. In particular, the specific models can constitute or comprise computer models, which models, for example, can thus be executed by means of a corresponding computer device. A computer device of this type can be configured, for example, as a controller, a control device or similar, in particular as an element of a protective device which is designed for executing the method according to the invention.

According to a potential further development of the present invention, a temporal characteristic of an electric voltage in the device is measured, and is employed as an input for the models. The electric voltage can be measured, for example, between two stipulated or predefined points on the device and/or on the fuse, and/or in relation to ground, earth or similar. In particular, this can be an operating voltage of the device in which, in the event of the occurrence of a fault, fluctuations or deviations from the value or characteristic thereof in no-fault normal operation are anticipated. A voltage of this type can be measurable in a comparatively simple, uncomplex, rapid and accurate manner, and thus represents an effective option or basis for enabling an ultimate distinction between a normal operating current rise and a fault current rise on the basis thereof.

According to a potential further development of the present invention, as parameters of the models, at least one equivalent resistance, one inductance and one component capacitance of the device are employed, having parameter values which are individually specified or adapted for the respective device. The equivalent resistance can be, for example, a combination of the resistance of a line which is to be protected by means of the fuse and the equivalent series resistance (ESR) of the capacitance thereof, or a corresponding short-circuit resistance. The inductance can constitute or comprise, for example, a line inductance of the line which is to be protected, or similar. The component capacitance can be, for example, a capacitive load which is supplied via the fuse or via the line which is to be protected, or similar. The various models can respectively include one or more of these parameters. In particular, it is not necessary for the parameters of the models to be mutually congruent. Thus, for example, the first model for determining the anticipated normal operating current or the anticipated normal operating current rise can include all three of the above-mentioned parameters, whereas a second model for determining the anticipated fault current or fault current rise, for example, can include only two of the above-mentioned parameters, for example only the equivalent resistance and the inductance, or similar. By means of the parameters described herein, current rises can be modelled and ultimately determined in a manner which is particularly simple and uncomplex, and which is simultaneously accurate and reliable.

According to a further potential configuration of the invention, an electronic fuse is employed as the fuse. This fuse is actuated for the tripping thereof, in order to interrupt a conduction of current through the fuse. Further to such tripping, the fuse is then automatically reset to a conducting state, immediately a stipulated reclosing or reset criterion is fulfilled. A reset criterion of this type can constitute or comprise, for example, an expiry of a stipulated time interval and/or an undershoot of a stipulated reclosing current threshold value for a current or, for example, of a voltage which is applied on one side of the fuse, vis-à-vis a stipulated measuring or reference point or potential, or similar. In this manner, both an effective protection of the device and a particularly robust and convenient operation of the device can be enabled. Thus, for example, in the event that the fault responsible for the original tripping of the fuse has been cleared, the supply of the device via the fuse can be automatically continued, and thus resumed. This is enabled by the employment of an electronic fuse, as a fuse of this type, for example in comparison with a conventional fusible link or similar, is repeatedly and reversibly switchable, and can thus be tripped and reclosed. This can also enable a correspondingly cost-effective protection of the respective device, as it is not then necessary for the fuse to be replaced after each tripping. Moreover, the electronic fuse, for example in comparison with conventional fusible links, can be operated or tripped in a significantly more rapid manner, for example with a switching time or tripping time of the order of a few μs, as against a number of ms. Likewise, the employment of an electronic fuse can enable a more accurate adaptability to the device or line which is to be protected and thus, for example, a correspondingly stricter design rating or more effective exploitation of the corresponding device or line.

According to a further potential configuration of the invention—as an element of conditions for identifying the measuring current as a fault current—the stipulated threshold values are rated such that, in the event of a fault, particularly in the event of a short-circuit, the fuse trips, and is thus opened, in response to a quantitatively lower fault current, and thus in response to a lower measuring current, than would apply in the case of an exclusively overcurrent-based tripping of the fuse, in an otherwise identically configured device or protective device. An exclusively overcurrent-based tripping, in the present sense, would apply in the event that, as a single condition for the tripping of the fuse, it were to be stipulated, or a check were to be executed to the effect that the measuring current exceeds a predefined maximum value, which would still be anticipated in a no-fault normal operation of the device, by at least a stipulated value. However, although this value can be minimized, a certain minimum magnitude must nevertheless be assumed, for example on the grounds of tolerances, measurement uncertainties, a limited accuracy of the predicted behavior of the device in no-fault normal operation, and/or similar. Conversely, by means of the design rating proposed herein, a prompter, but nevertheless accurate and reliable automatic tripping of the fuse can be enabled. As a result, as described elsewhere, for example, a build-up of energy associated with a fault or with the automatic tripping of the fuse can be reduced and thus, ultimately, a superior security is achieved and/or a correspondingly reduced and more cost-effective tripping of associated components is enabled.

The present invention also relates to a protective device for protecting an electrical or electronic device against a fault current. The protective device according to the invention comprises an electronically actuatable fuse, a measuring device for measuring a current which flows in the fuse during operation, and a control device for actuating the fuse in consideration of the measured current. The protective device according to the invention, or the control device thereof, is designed, in particular, for the automatic execution or application of the method according to the invention. The protective device according to the invention, in particular, can be the protective device which is specified in connection with the method according to the invention, or can correspond thereto. Correspondingly, the protective device according to the invention can comprise a number or all of the properties and/or features specified in this connection.

According to a potential further development of the present invention, the fuse can be configured as a reversibly switchable electronic fuse, which comprises at least one actuatable transistor, in particular a MOSFET. The fuse can thus be actuated in a particularly simple manner, and can assume a particularly short switching time. Moreover, the avalanche effect of the transistor can then be employed or exploited, in order to enable a freewheeling of the resulting current further to the tripping of the fuse, and thus the gradual decay thereof. This can prevent the generation of destructive voltage spikes, which might otherwise result in damage to the device and/or to other components, notwithstanding the tripping of the fuse. Exploitation of the avalanche effect can thus represent a particularly cost-effective and uncomplex option. This option is enabled by the present invention on the grounds that, at a result of the current gradient-based tripping of the fuse, vis-à-vis a conventional overcurrent trip circuit or overcurrent tripping function, the maximum quantity of freewheeling energy further to the tripping of the fuse is reduced, and the risk of any overloading of the transistor or of the avalanche effect can be restricted to practicably manageable values.

According to a potential further development of the present invention, the protective device comprises a freewheeling diode. A freewheeling diode of this type, further to the tripping of the fuse, can enable a freewheeling of residual energy or a freewheeling and gradual decay of the resulting current. As a result, damage, for example associated with an uncontrolled voltage rise further to the tripping of the fuse, can be prevented. The proposed employment of a freewheeling diode for this purpose, by means of the present invention, can be achieved in a particularly simple, secure and reliable manner, on the grounds that, as a result of the current gradient-based tripping of the fuse, the quantity of freewheeling energy, for example in comparison with conventional and exclusively overcurrent-based trip functions, can be reduced and, as a result, any overloading of the freewheeling diode—even in the event of a simple and cost-effective design—can be reliably prevented with no further measures. The employment of a freewheeling diode can thus represent a particularly simple, cost-effective and effective option for further protection.

The present invention also relates to a motor vehicle having an on-board electric power supply system and a protective device according to the invention which is integrated therein. Given that current motor vehicles, frequently employ relatively high operating voltages, and relatively large quantities of electrical energy can be transmitted in the on-board power supply system thereof, which vehicles, moreover, can incorporate an increasing variety of electronic components and systems which are susceptible responsive to fault currents, short-circuits, voltage spikes or similar, a particularly useful application of the method according to the invention or of the protective device according to the invention is thus provided. Moreover, by means of the present invention, as a result of the limitation of the quantity of freewheeling energy further to the tripping of the fuse, the protection of vehicle occupants can be ensured or improved in a particularly simple, effective and efficient manner, and thus, for example, with no additional cost- or weight-intensive measures.

Further features of the invention can be inferred from the claims, the figures and the description of the figures. Features and combinations of features specified in the preceding description, and features and combinations of features illustrated hereinafter in the description of the figures and/or in the figures alone, are not only applicable in the respectively indicated combination, but also in other combinations or in isolation, without departing from the scope of the invention.

### BRIEF DESCRIPTION OF THE DRAWINGS

FIG. 1 shows an exemplary schematic diagrammatic representation of temporal characteristics of an electronic device, and of a short-circuit current, for the illustration of an overcurrent trip circuit;

FIG. 2 shows an exemplary schematic diagrammatic representation of temporal characteristics of current rises of operating current in various configurations of an electronic device, and of a short-circuit current, for the illustration of a current gradient-based tripping function; and

FIG. 3 shows an exemplary diagram for the illustration of an implementation the current gradient-based tripping function.

### DETAILED DESCRIPTION OF THE DRAWINGS

In the figures, identical and functionally equivalent elements are identified by the same reference symbols.

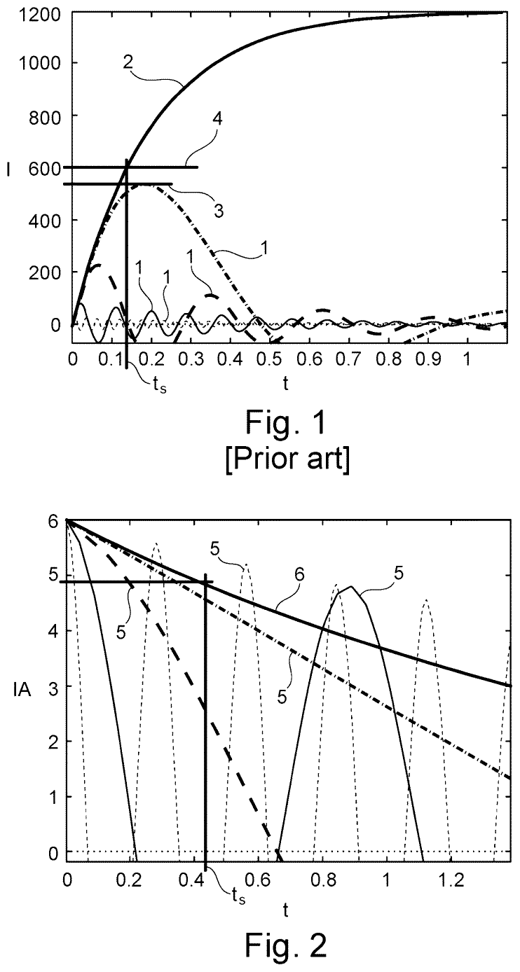

In order to prevent damage to components, and in the interests of improved functional security, electrical or electronic devices can be protected by means of an electronic fuse. However, the promptest possible tripping of such fuses in the event of a fault, whilst preventing any unnecessary tripping in the case of no-fault normal operation, represents a challenge. For the purposes of illustration, FIG. 1 shows an exemplary schematic diagrammatic representation, in which time t is plotted on the x-axis, and the current I which, for example, can flow through a fuse during operation, is plotted on the y-axis. Various characteristics of a normal operating current 1 for different capacitances of a supplied load are plotted herein. Moreover, a characteristic of a short-circuit current 2 associated with the occurrence of a fault is also plotted. It can be seen here that, below a routinely occurring maximum operating current 3 in no-fault normal operation, the normal operating current 1 is not reliably distinguishable from the short-circuit current 2. In the present exemplary case, the maximum operating current 3 is approximately 580 A, at a load capacitance of 10 mF in the present example. Although, at lower load capacitances, the maximum operating current 3 can be lower, a similar rise in current can nevertheless occur in each case, up to the respective maximum operating current 3—independently of whether a fault is present or otherwise.

Were a conventional overcurrent trip circuit to be employed in this case, provision might be made for an opening, and thus a tripping of the fuse, at a threshold value 4 which exceeds the routinely occurring maximum operating current 3. In the present exemplary case, this threshold value 4 can be approximately 600 A. In the present example, this threshold value 4 would be achieved at a tripping time tₛ of approximately 130 μs.

Such a relatively high current, particularly in the event of a simultaneously relatively high inductance on a line which is to be protected, can be particularly critical, as a correspondingly large quantity of energy E can then be accumulated, according to the formula:

E=½·L·I²

and it is necessary for this energy to be dissipated, in order to prevent an overvoltage further to the tripping of the fuse. This can be associated with a risk of the overloading of components such as, for example, a transistor of the fuse and/or a freewheeling diode. In principle, for the mitigation of this issue, the inductance L might be reduced, for example by the employment of shorter conductors. In many applications, however, for example in the case of a motor vehicle, this option is not readily possible, as conductor lengths, for example as a result of given dimensions of the motor vehicle or a given geometry of a cable harness or similar, are essentially defined in a fixed manner.

As an alternative approach, consequently, a potentially earlier tripping time tₛ can be pursued or defined.

To this end, FIG. 2 shows an exemplary schematic diagrammatic representation for the illustration of current gradient-based opening or tripping of the fuse. Here again, the time t is plotted on the x-axis. In this case, conversely, the rate of current rise LA is plotted on the y-axis. Exemplarily, in an analogous manner to FIG. 1, multiple different normal operating current rises 5, the occurrence of which might be associated with different load capacitances, are plotted. Moreover, for the illustration of a fault in the present case, a short-circuit current rise 6 is plotted. Monitoring of the rate of current rise IA in the current I flowing through the fuse, in comparison with a conventional overcurrent trip circuit based upon an absolute value of the current I, enables a prompter detection of a fault current or of a short-circuit. Thus—according to the load capacitance—a corresponding fault current or short-circuit can be correspondingly detected more promptly, with a given confidence interval. Exemplarily, in turn, at a load capacitance of 10 mF, after approximately 45 μs, it is already possible to distinguish between the short-circuit and normal operation with a practicable confidence interval. In other words, a detection of the short-circuit, and thus a corresponding automatic tripping of the fuse, can be executed as early as a tripping time tₛ=45 μs, and thus significantly earlier than the tripping time tₛ=130 μs illustrated in FIG. 1 for the corresponding overcurrent trip circuit.

At the earlier tripping time tₛ=45 μs thus enabled, the current I is only approximately 200 A, and is thus significantly lower than the value of approximately 600 A occurring in FIG. 1 at the time tₛ=130 μs—notwithstanding the otherwise identical configuration of the device and fuse represented. Thus, in the corresponding example, further to the tripping of the fuse, the resulting quantities of freewheeling energy are approximately 360 mJ in the overcurrent trip circuit illustrated in FIG. 1, and approximately 40 mJ in the current gradient-based tripping function illustrated in FIG. 2. Thus, by the consideration of the rate of current rise IA in a condition or criterion for the automatic tripping of the fuse, an exemplary reduction of approximately 89% in the subsequent quantity of freewheeling energy is thus achieved.

Accordingly, an improved protection of equipment, an improved overcurrent-time protection, undervoltage protection and protection against thermal overload can be achieved or improved. Thus, in a comparatively simple manner, an exemplary and improved functional security of ASIL-classified components can be achieved.

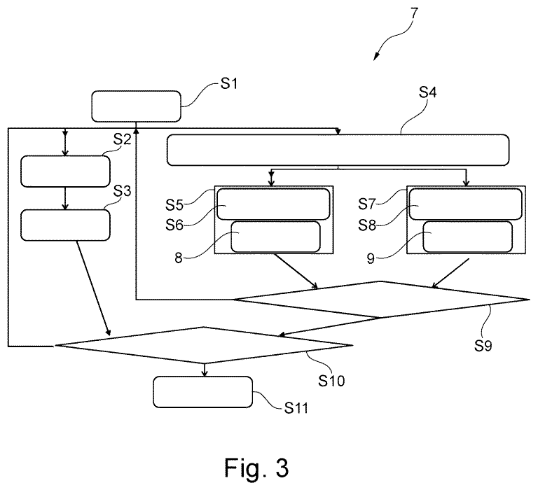

For the purposes of further illustration, FIG. 3 shows an exemplary diagram 7 of a method for protecting an electrical or electronic device by means of a fuse which can be automatically tripped according to the rate of current rise IA. The method commences with a process step S1. Herein, for example, a corresponding protective device, or the electrical or electronic device which is protected by means thereof, can be commissioned or set up, for example by the definition or loading of parameter values, models, threshold values and/or similar. In a process step S2, a temporal characteristic of the current I(t) in the fuse in measured. In a process step S3, the respective present rise or gradient m_{iMess} of the measured current I(t) is determined herefrom.

At the same time, in a process step S4, the temporal characteristic of the current I(t) can be calculated. By means of two specific models, two corresponding current rises or gradients can be calculated. Firstly, in a process step S5, the respective presently anticipated current rise m_{iLoad} in no-fault normal operation can be calculated. Additionally, in a process step S6, a correspondingly specified normal operating model 8 can be applied or evaluated:

$$\frac{du ( t )}{dt} = \frac{dI ( t )}{dt} \cdot R + \frac{{d}^{2} I ( t )}{{dI}^{2}} \cdot L + I ( t ) \cdot \frac{1}{C}$$

Herein, u(t) is the temporal voltage characteristic, R is a stipulated equivalent resistance, L is a stipulated inductance and C is a stipulated capacitance in the respective device or load.

Secondly, in a parallel manner hereto, in a process step S7, a respective presently anticipated current rise mise in the event of a fault or a short-circuit can be calculated. To this end, in a process step S8, a correspondingly specified short-circuit model 9 can be applied or evaluated. This short-circuit model, for example, can be specified as follows:

$$u ( t ) = I ( t ) \cdot R + \frac{dI ( t )}{dt} \cdot L$$

In a process step S9, a check can then be executed as to whether a stipulated deviation condition between the anticipated current rise m_{iLoad} in no-fault normal operation and the anticipated current rise m_{iSC} in the event of a fault is fulfilled:

|m_{iSC}|>(1+δ)|m_{iLoad}|

Herein, δ is a stipulated confidence interval pursued, for example approximately 10%, for the distinction between a short-circuit or a fault and normal operation. If this first condition is not fulfilled, the method, as described above, can be continued by the execution of a further cycle. Thus, for example, the respective next anticipated values for the current rises m_{iLoad} and mise can be calculated.

If, conversely, in process step S9, the first condition is fulfilled, the method can be continued in a process step S10. Herein, a second stipulated condition can be checked:

|m_{iMess}−m_{iSC}|<(1+δ)|m_{iSC}|

A check can thus be executed as to whether the measured current rise m_{iMess} previously determined and the presently anticipated current rise m_{iSC} in the event of a fault, according to a stipulated condition, coincide to a sufficiently close margin to enable the actual identification of a fault or short-circuit with the stipulated confidence interval δ. In this case, for example, δ can assume the same value as that applied for the checking of the first condition in process step S9. However, a different stipulated value for δ can also be employed. If this second condition is not fulfilled, the method can likewise be continued by the execution of a further cycle, as described above.

If, conversely, it is established in step S10 that the second condition is also fulfilled, this can be interpreted as the detection of a fault or fault current, or of a short-circuit. Accordingly, in a process step S11, the fuse can be automatically tripped, and thus opened.

Overall, the examples described illustrate how a current gradient-based tripping or opening of electronic fuses can be achieved for the particularly reliable, secure and prompt protection of electrical and/or electronic devices.

### LIST OF REFERENCE SYMBOLS

1 Normal operating current
2 Short-circuit current
3 Maximum operating current
4 Threshold value
5 Normal operating current rise
6 Short-circuit current rise
7 Diagram
8 Normal operating model
9 Short-circuit model
S1-S11 Process steps
I Current
IA Rate of current rise
t Time
tₛ Tripping time

1-10. (canceled)

11. A method for protecting an electrical and/or electronic device against a fault current by means of a fuse, the method comprising:
determining a respective presently anticipated normal operating current under no-fault conditions at a stipulated location in the device and a corresponding present normal operating current rise;
determining a respective presently anticipated fault current at the stipulated location and a corresponding fault current rise;
measuring an actual current flowing through the stipulated location over time, and determining a respectively corresponding present measuring current rise;
detecting the measured current as a fault current and automatically tripping the fuse when:
the presently anticipated fault current rise exceeds the presently anticipated normal current rise by a margin which exceeds a stipulated threshold value; and
at the same time a differential between the presently anticipated fault current rise and the present measuring current rise is lower than a stipulated differential threshold value.

12. The method according to claim 11, wherein the anticipated normal operating current rise and the anticipated fault current rise are calculated using two different specific models.

13. The method according to claim 12, wherein a temporal characteristic of an electric voltage in the device is measured, and is employed as an input for the models.

14. The method according to claim 12, wherein as parameters of the models, an equivalent resistance, an inductance and a component capacitance of the device are employed, having parameter values which are individually specified for the respective device.

15. The method according to claim 11, wherein:
an electronic fuse is employed as the fuse; and
the fuse is actuated for the tripping thereof in order to interrupt a conduction of current and, further to such tripping, is then automatically reset to a conducting state, immediately a stipulated reset criterion is fulfilled.

16. The method according to claim 11, wherein:
the stipulated threshold values are rated such that, in the event of a fault, the fuse trips in response to a quantitatively lower fault current than would apply in the case of an exclusively overcurrent-based tripping of the fuse, in an otherwise identically configured device.

17. A protective device for protecting an electrical or electronic device against a fault current, comprising:
an electronically actuatable fuse;
a measuring device configured to measure a current which flows in the fuse during operation; and
a control device configured to actuate the fuse in consideration of the measured current;
wherein the protective device is designed for executing a method according to claim 11.

18. The protective device according to claim 17, wherein the fuse is configured as a reversibly switchable electronic fuse which comprises at least one actuatable transistor.

19. The protective device according to claim 18, wherein the at least one actuable transistor comprises a MOSFET.

20. The protective device according to claim 17, wherein the protective device comprises a freewheeling diode.

21. A motor vehicle, comprising an on-board electric power supply system and a protective device according to claim 17.
